(19) United States
(12) Patent Application Publication
(10) Pub. No.: US 2021/0310217 A1
(43) Pub. Date: Oct. 7, 2021

(54) DATA COLLECTION DEVICE FOR CONSTRUCTION MACHINERY, DATA PROVIDING SYSTEM FOR CONSTRUCTION MACHINERY, AND DATA COLLECTION METHOD FOR CONSTRUCTION MACHINERY

(71) Applicant: KOMATSU LTD., Tokyo (JP)

(72) Inventors: Naoki AKIYAMA, Tokyo (JP); Jun YAMANE, Tokyo (JP); Hirotaka YUNO, Tokyo (JP); Naoto KISHI, Tokyo (JP)

(21) Appl. No.: 17/269,355

(22) PCT Filed: Aug. 16, 2019
(86) PCT No.: PCT/JP2019/032116

§ 371 Date: Feb. 18, 2021

(30) Foreign Application Priority Data
Sep. 28, 2018 (JP) 2018-185905

(51) Int. Cl. E02F 9/26; G07C 5/08; G07C 5/00

(52) U.S. Cl. CPC E02F 9/26; H04L 67/12; G07C 5/008; G07C 5/085

(57) ABSTRACT

A data collection device for work machines collects data from a component mounted on a work machine. The data collection device includes a collection unit that collects the data from the component via a vehicle-mounted network, and a conversion unit that generates a unified data object by converting the collected data into a predetermined format, and a data transmission unit that transmits the unified data object to the outside.

### CROSS-REFERENCE TO RELATED APPLICATIONS

This application is a U.S. National stage application of International Application No. PCT/JP2019/032116, filed on Aug. 16, 2019. This U.S. National stage application claims priority under 35 U.S.C. § 119(a) to Japanese Patent Application No. 2018-185905, filed in Japan on Sep. 28, 2018, the entire contents of which are hereby incorporated herein by reference.

### BACKGROUND

### Field of the Invention

The present invention relates to a data collection device, a data providing system, and a data collection method that collect data from a component mounted on a work machine.

### Background Information

Japanese Unexamined Patent Application, First Publication No. 2014-177816 discloses a technique of collecting information on a work machine from the work machine.

### SUMMARY

Components mounted on a work machine are generally connected to a controller area network (CAN). A data frame used in the communication of the CAN has a data part of up to 8 bytes for storing a value. A data frame of the CAN is usually transmitted by storing a plurality of types of data values in a data part. The content and storage position of the value stored in the data part is determined by the format of the data frame, and the format varies depending on the type and model of the component. For that reason, in a technique described in Japanese Unexamined Patent Application, First Publication No. 2014-177816, in order to acquire data from a component, it is necessary to know the format of the data frame used in advance in the component. However, it is difficult to know in advance what kind of component a work machine serving as a data collection target include and what kind of format the component stores the value in.

An object of the present invention is to provide a data collection device for work machines, a data providing system for work machines, and a data collection method for work machines that can easily acquire desired data related to a work machine from the outside of the work machine.

According to a first aspect of the present invention, a data collection device is a data collection device that collects data from a component mounted on a work machine. The data collection device includes a data collection unit that collects the data from the component in accordance with an individual protocol of the component; a conversion unit that generates a unified data object by converting the collected data into a predetermined format; and a data transmission unit that transmits the unified data object to the outside.

According to the above aspect, desired data relating to a work machine can be easily acquired from the outside of the work machine.

### BRIEF DESCRIPTION OF DRAWINGS

FIG. 1 is a configuration view of a data providing system according to a first embodiment.

FIG. 2 is a view showing the format of a unified format.

FIG. 3 is a perspective view showing the appearance of a work machine.

FIG. 4 is a block diagram showing a configuration of a control system of the work machine.

FIG. 5 is a view showing an example of data collection and conversion.

FIG. 6 is a view showing a data structure of a collection method table.

FIG. 7 is a view showing a data structure of a processing condition table.

FIG. 8 is a view showing a data structure of a collectable table.

FIG. 9 is a view showing a data structure of a data table.

FIG. 10 is a block diagram showing a configuration of a data server according to the first embodiment.

FIG. 11 is a view showing an example of information stored in a definition database according to the first embodiment.

FIG. 12 is a sequence view showing a method of setting processing conditions in the data providing system according to the first embodiment.

FIG. 13 is a sequence view showing a method of collecting data in the data providing system according to the first embodiment.

FIG. 14 is a sequence view showing a method of transmitting data in the data providing system according to the first embodiment.

FIG. 15 is a sequence view showing a method of presenting data in the data providing system according to the first embodiment.

### DETAILED DESCRIPTION OF EMBODIMENT(S)

### First Embodiment

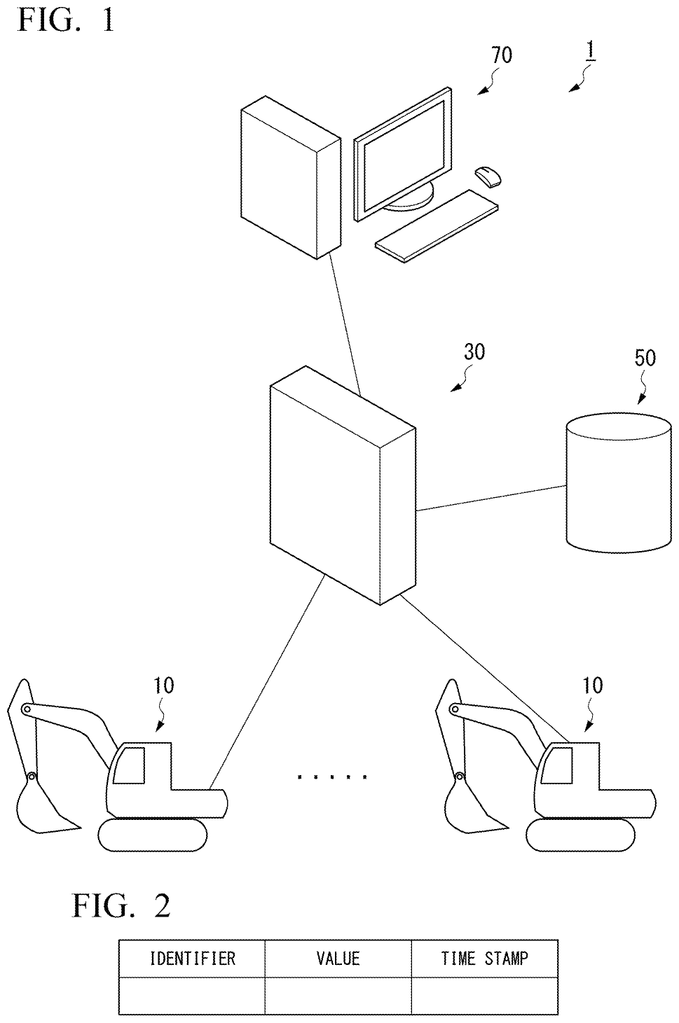

FIG. 1 is a configuration view showing an overall configuration of a data providing system 1 according to a first embodiment.

The data providing system 1 provides data related to the plurality of work machines 10 for use by a user. The data providing system 1 includes a plurality of work machines 10, a data server 30, a definition database 50, and a user device 70. Each work machine 10 collects data related to the work machine 10 and transmits the data to the data server 30. The data server 30 stores the data collected from the plurality of work machines 10 and provides the data to the user device 70. The definition database 50 stores information necessary for providing data by the data server 30. The user device 70 sets the conditions of the data to be collected by each work machine 10 and also acquires the data related to the work machine 10 from the data server 30. Although a hydraulic excavator is shown as the work machine 10 in FIG. 1, other work machines may be used, for example, a bulldozer, a dump truck, or a wheel loader.

In a case where communication of the data related to the work machine 10 between the work machine 10 and the data server 30 and between the data server 30 and the user device 70, the communication using unit data related to the unified format is performed. The unified format is a unit data format that stores the value of one type of data. The work machine 10 stores a plurality of values included in the unit data of a CAN collected from respective components in the unit data in the unified format and transmits the values to the data server 30. The unit data is also called a data frame, a packet, or a protocol data unit (PDU).

Hereinafter, the data in the format of the unified format is referred to as a unified data object.

FIG. 2 is a view showing the format of the unified format.

The unified format stores an identifier indicating the type of data, a value of the data, and a time stamp indicating the time when each component have acquired the data. Only one identifier, one value, and one time stamp are stored in one unified data object.

### (Configuration of Work Machine 10)

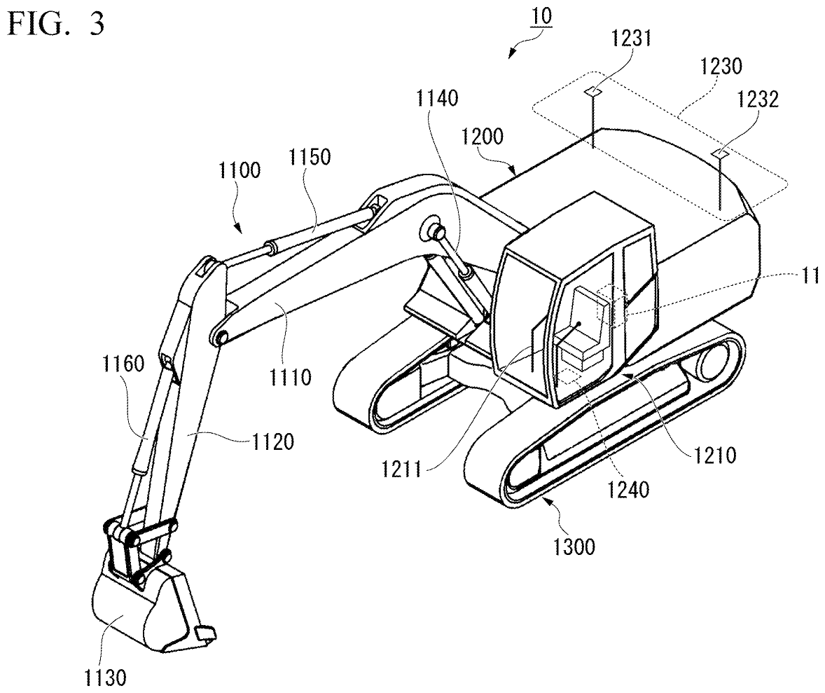

FIG. 3 is a perspective view showing the appearance of the work machine 10.

The work machine 10, which is a work machine, includes a piece of work equipment 1100 that is hydraulically activated, a swing body 1200 that supports the work equipment 1100, and a carriage 1300 which supports the swing body 1200.

### (Work Equipment 1100)

The work equipment 1100 includes a boom 1110, an arm 1120, a bucket 1130, a boom cylinder 1140, an arm cylinder 1150, and a bucket cylinder 1160.

The boom 1110 is a strut that supports the arm 1120 and the bucket 1130. A proximal end part of the boom 1110 is attached to a front part of the swing body 1200 via a pin.

The arm 1120 couples the boom 1110 to the bucket 1130. The proximal end part of the arm 1120 is attached to a distal end part of the boom 1110 via a pin.

The bucket 1130 is a container having a blade for excavating earth or the like. A proximal end part of the bucket 1130 is attached to a distal end part of the arm 1120 via a pin.

The boom cylinder 1140 is a hydraulic cylinder for activating the boom 1110. A proximal end part of the boom cylinder 1140 is attached to the swing body 1200. A distal end part of the boom cylinder 1140 is attached to the boom 1110.

The arm cylinder 1150 is a hydraulic cylinder for driving the arm 1120. The proximal end part of the arm cylinder 1150 is attached to the boom 1110. A distal end part of the arm cylinder 1150 is attached to the arm 1120.

The bucket cylinder 1160 is a hydraulic cylinder for driving the bucket 1130. A proximal end part of the bucket cylinder 1160 is attached to the arm 1120. A distal end part of the bucket cylinder 1160 is attached to the bucket 1130.

### (Swing Body 1200)

The swing body 1200 is provided with a cab 1210 on which an operator gets. The cab 1210 is provided in front of the swing body 1200 and on the left side of the work equipment 1100.

An operating device 1211 for operating the work equipment 1100 is provided inside the cab 1210. Hydraulic oil is supplied to the boom cylinder 1140, the arm cylinder 1150, and the bucket cylinder 1160 depending on the amount of operation of the operating device 1211, and the work equipment 1100 is driven.

### (Component)

The work machine 10 includes a position and azimuth direction calculator 1230 and a tilt detector 1240. The position and azimuth direction calculator 1230 and the tilt detector 1240 are examples of the components. Additionally, the work machine 10 includes a data collection device 11 that collects data related to the work machine 10 and transmits the data to the data server 30. The data collection device 11 is provided in the cab 1210. A control component 12 and an extension component 14 to be described below may be similarly provided in the cab 1210, for example, may be provided outside the cab 1210 on the swing body 1200.

The position and azimuth direction calculator 1230 calculates the position of the swing body 1200 and the azimuth direction in which the swing body 1200 faces. The position and azimuth direction calculator 1230 includes a first receiver 1231 and a second receiver 1232 that receive positioning signals from an artificial satellite that constitute a global navigation satellite system (GNSS). The first receiver 1231 and the second receiver 1232 are installed at different positions on the swing body 1200. The position and azimuth direction calculator 1230 detects the position of a representative point O (the origin of a vehicle body coordinate system) of the swing body 1200 in a field coordinate system on the basis of a positioning signal received by the first receiver 1231.

The position and azimuth direction calculator 1230 calculates the azimuth direction of the swing body 1200 a relationship of the installation position of the second receiver 1232 with respect to the detected installation position of the first receiver 1231, using the positioning signal received by the first receiver 1231 and the positioning signal received by the second receiver 1232.

The tilt detector 1240 detects the acceleration and angular velocity of the swing body 1200, the tilt of the swing body 1200 on the basis of the measurement results (for example, the rolling representing rotation with respect to an Xm-axis, the pitching representing the rotation with respect to a Ym axis, and yawing representing the rotation with respect to a Zm axis). The tilt detector 1240 is installed, for example, on a lower surface of the cab 1210. As the tilt detector 1240, for example, an inertial measurement unit (IMU), which is an inertial measurement device, can be used.

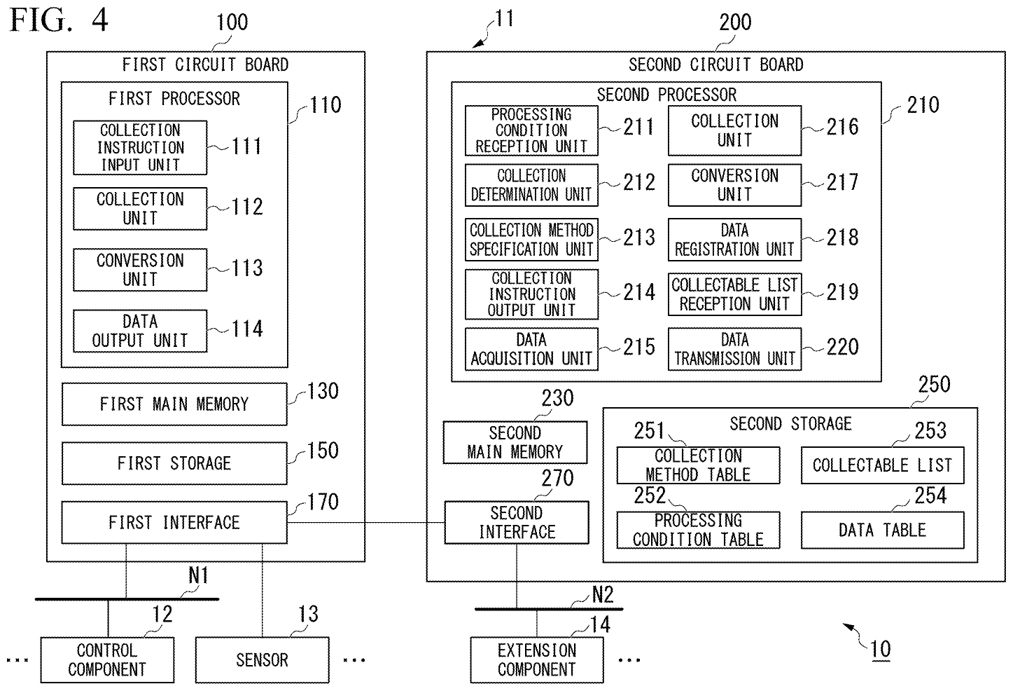

FIG. 4 is a block diagram showing a configuration of a control system of the work machine 10.

The data collection device 11 includes a first circuit board 100 and a second circuit board 200 that are physically divided. The first circuit board 100 constitutes a computer that runs a real-time operating system (OS). The second circuit board 200 constitutes a computer that runs a general-purpose OS.

The first circuit board 100 includes a first processor 110, a first main memory 130, a first storage 150, and a first interface 170. The first processor 110 reads a program from the first storage 150, develops the program into the first main memory 130, and executes predetermined processing in accordance with the program. The first interface 170 is connected to a plurality of the control components 12 for controlling the work machine 10 via a first network N1. Examples of the control components 12 include an engine control component that acquires various engine-related data with a sensor and controls the engine, a hydraulic pressure control component that acquires various hydraulic-equipment-related data for controlling the operation of the work equipment 1100 by using a sensor and controls the hydraulic equipment, a monitor control component that acquires data from various sensors of the work machine 10 and performs the display control of a monitor (not shown), a communication component that acquires communication equipment for communicating with an external server and acquires data from various sensors of the work machine, and the like. The first network N1 is, for example, a CAN. Additionally, the first interface 170 is connected to a sensor 13 that detects the state quantity of the work machine 10. The control components 12 and the sensor 13 are examples of the components mounted on the work machine 10. The control components 12 connected to the first network N1 perform basic operation control of the work machine 10.

The second circuit board 200 includes a second processor 210, a second main memory 230, a second storage 250, and a second interface 270. The second processor 210 reads a program from the second storage 250, develops the program into a second main memory 230, and executes predetermined processing in accordance with the program. The second interface 270 is connected to a plurality of the extension components 14 for extending the functions of the work machine 10 via the second network N2. Examples of the extension components 14 include, an image display component that performs predetermined image processing on an image captured by a camera and controls the display thereof, a machine guidance component that displays and controls a guidance monitor for guiding a positional relationship or the like between the design surface of a construction site and the work machine 10 to the operator, a payload component for measuring the amount of soil excavated by the work equipment 1100, and the like. The second network N2 is, for example, a CAN or Ethernet (registered trademark). The extension components 14 are examples of the components mounted on the work machine 10. The provision of with extended information to the work machine 10 and the operator is performed by the extension components 14 connected to the second network N2.

The first interface 170 and the second interface 270 are communicably connected to each other.

The program stored in the first storage 150 or the second storage 250 may be for realizing some of the functions exhibited by the first circuit board 100 or the second circuit board 200. For example, the program may exhibit the functions in combination with another program already stored in the first storage 150 or the second storage 250 or in combination with another program mounted on another device. In addition, in another embodiment, the first circuit board 100 or the second circuit board 200 may include a custom large scale integrated circuit (LSI) such as a programmable logic device (PLD) in addition to or instead of the above configuration. Examples of PLDs include a programmable array logic (PAL), a generic array logic (GAL), a complex programmable logic device (CPLD), and a field programmable gate array (FPGA). In this case, some or all of the functions realized by the first circuit board 100 or the second circuit board 200 may be realized by the integrated circuit.

Examples of the first storage 150 and the second storage 250 include a hard disk drive (HDD), a solid state drive (SSD), a magnetic disk, a magneto-optical disk, a compact disc read only memory (CD-ROM), a digital versatile disc read only memory (DVD-ROM), a semiconductor memory, and the like. The first storage 150 and the second storage 250 may be internal media directly connected to a bus line or external media connected to the data collection device 11 via the first interface 170 or a communication line. Additionally, this program may be distributed to the data collection device 11 by the communication line, and the first processor 110 or the second processor 210 may execute the program. In at least one embodiment, the first storage 150 and the second storage 250 are non-transitory tangible storage media.

The first processor 110 functions as a collection instruction input unit 111, a collection unit 112, a conversion unit 113, and a data output unit 114 by executing a program stored in the first storage 150.

The collection instruction input unit 111 receives input of a collection instruction including a data collection method from the second circuit board 200. The collection method is information for specifying a region where the value of a collection target is stored in a data part of the unit data related to a CAN format generated by each control component 12 or the sensor 13.

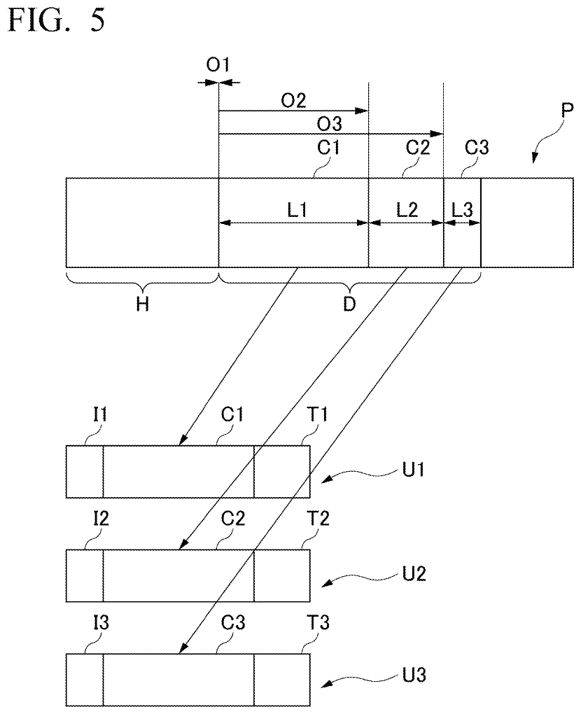

FIG. 5 is a view showing an example of data collection and conversion. Unit data P has a header part H and a data part D. The header part H stores various information related to the unit data P, for example, the type of the unit data P is stored. The data collection method stored in the data part D of the unit data P is specified by the type of the unit data P. As the type of unit data P, for example, there is the ID number of J1939:1. The value is a predetermined data value allocated to the data part D and is stored in a predetermined region of the data part D. The value is specified by an offset indicating the number of bits from the head of the data part D to the start point of the value and a data length indicating the size of the value. In an example shown in FIG. 5, three values C1, C2, and C3 are allocated to the data part D of the unit data P. A value C1 is specified by an offset O1 and a data length L1. A value C2 is specified by an offset O2 and a data length L2. A value C3 is specified by an offset O3 and a data length L3. For example, engine speed is stored in the value C1, for example, engine torque is stored in the value C2, and for example, engine water temperature is stored in the value C3. In addition, the allocation of the values in the data part D is not limited to that shown in FIG. 5. For example, the number of the values may be two or less or four or more, and the contents of the respective values may be different from each other.

The format of the unit data handled in communication via a CAN varies depending on the type and model of the control component 12 and the sensor 13. An example of the format of the unit data includes SAE J1939 or the like. Rules for the format of the unit data may be optionally set by a designer. Additionally, in the unit data of the CAN, a plurality of values are set in a data part of up to 8 bytes and stored in a predetermined storage region. For that reason, even when the values of the same type of data are given, there is a possibility that the position and size of the values stored in the data part vary depending on the format of the unit data.

For that reason, the collection method includes the type of the format, the value of the offset and the value of the data length.

The collection unit 112 collects data from the control component 12 or the sensor 13 in accordance with a collection method included in a collection instruction input to the collection instruction input unit 111. Specifically, the collection unit 112 specifies the type of unit data from a header part on the basis of a collection method, then specifies a storage region in which the value of a collection target is stored and collects a value stored in the specified storage region from the unit data transmitted from the control component 12 or the sensor 13.

The conversion unit 113 generates a unified data object by converting the data collected by the collection unit 112 into data in a unified format. Specifically, as shown in FIG. 5, the conversion unit 113 generates, for each of the plurality of values collected from the unit data P of the CAN data, a unified data object that stores the collected value and an identifier indicating the type of data related to the collected value. In the example shown in FIG. 5, the conversion unit 113 generates a unified data object U1 on the basis of the value C1, a unified data object U2 on the basis of the value C2, and a unified data object U3 on the basis of the value C3. The unified data object U1 includes an identifier I1 indicating the type of data having the value C1 and a time stamp T1 indicating the acquisition time of the value C1. The unified data object U2 includes an identifier I2 indicating the type of data having the value C2 and a time stamp T2 indicating the acquisition time of the value C2. The unified data object U3 includes an identifier 13 indicating the type of data having the value C3 and a time stamp T3 indicating the acquisition time of the value C3.

The first processor 110 extracts one value from the unit data by referring to the rules for the format of predetermined unit data from a collection method table and gives an identifier and a time stamp in the unified data format of the value to convert the identifier and the time stamp to one unified data format. By doing so, it is possible to easily utilize the data by associating one identifier with one optional data value and performing data management as the unified data format.

The data output unit 114 outputs the unified data object generated by the conversion unit 113 to the second circuit board 200.

The second processor 210 executes a program stored in the second storage 250 to function as a processing condition reception unit 211, a collection determination unit 212, a collection method specification unit 213, a collection instruction output unit 214, a data acquisition unit 215, a collection unit 216, a conversion unit 217, a data registration unit 218, a collectable list notification unit 219, and a data transmission unit 220. Additionally, a storage region for the collection method table 251, the processing condition table 252, the collectable table 253, and the data table 254 is secured in the second storage 250.

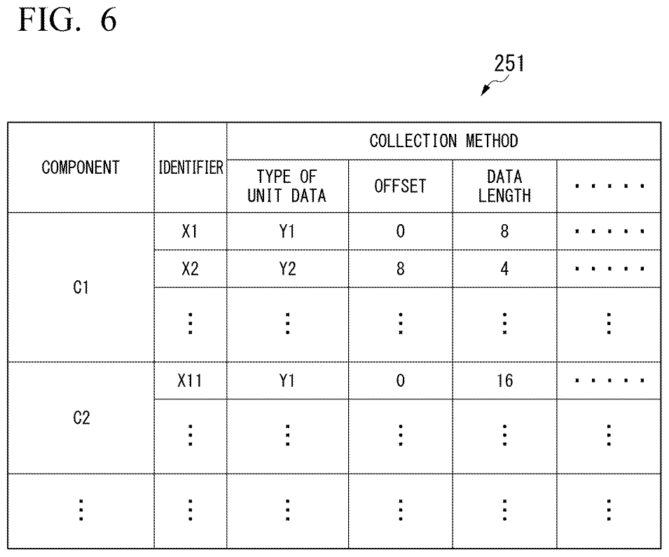

FIG. 6 is a view showing a data structure of the collection method table 251. In the collection method table 251, for each of the components (control component 12, sensor 13, and extension component 14), an identifier indicating the type of data that is acquirable from the component is stored in association with a data collection method in advance. The data collection method includes, for example, the type of unit data, the offset of a value allocated to a data part of the unit data, the data length of the value, and the like.

In addition, the type of data is not limited to the data acquired by each component from a sensor, for example, may include abnormality data in which each component detects an abnormality, obstacle data in which an obstacle including a person present around the work machine 10 is detected, image data captured by a camera (not shown) installed in the work machine 10, external environment data including ambient temperature data and humidity data outside the work machine 10, and current terrain data that is the measurement result of current state terrain around the work machine 10.

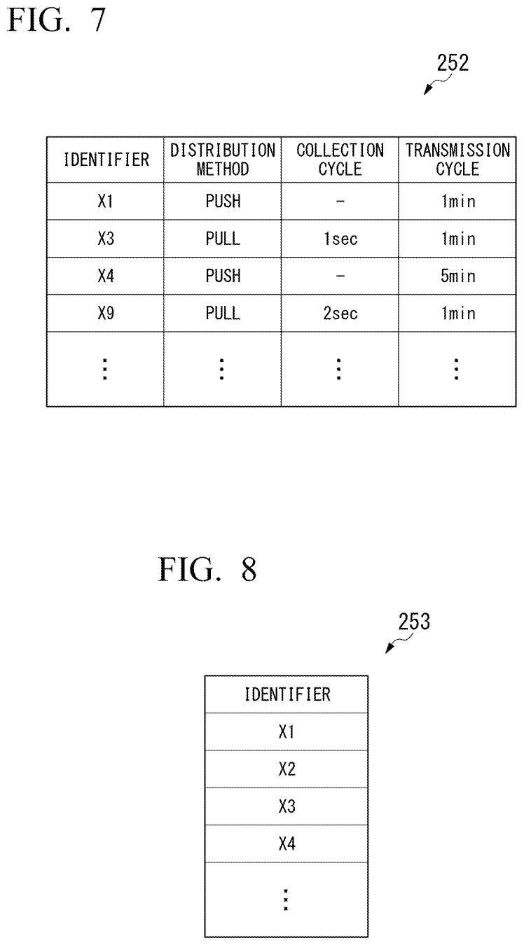

FIG. 7 is a view showing a data structure of the processing condition table 252. The processing condition table 252 stores an identifier indicating the type of data to be collected by the data collection device 11 and a distribution method, a collection cycle, and a transmission cycle of the data in association with each other. Examples of the distribution method of the data include a PULL method in which a component distributes data by receiving as a data request, and a PUSH method in which a component voluntarily distributes data. The PUSH method includes a method in which a component distributes data at each predetermined cycle and a method in which data is distributed when a predetermined event occurs. The collection cycle is a condition defined in a case where the distribution method is PULL. That is, the data collection device 11 transmits a data request to a component at a timing related to the collection cycle. In addition, in another embodiment, the data processing conditions may be further defined in the processing condition table 252. In this case, the processing condition table 252 may further store the processing conditions (not shown) in association with the identifier.

FIG. 8 is a view showing a data structure of the collectable table 253. The collectable table 253 stores identifiers related to all the data that is collectable by the plurality of components mounted on the work machine 10. The collectable table 253 is equivalent to merging all the identifiers associated with the respective components in the collection method table 251. The collectable table 253 may further store the initial value, the minimum values, the maximum values, the collection cycles, and the like of the data.

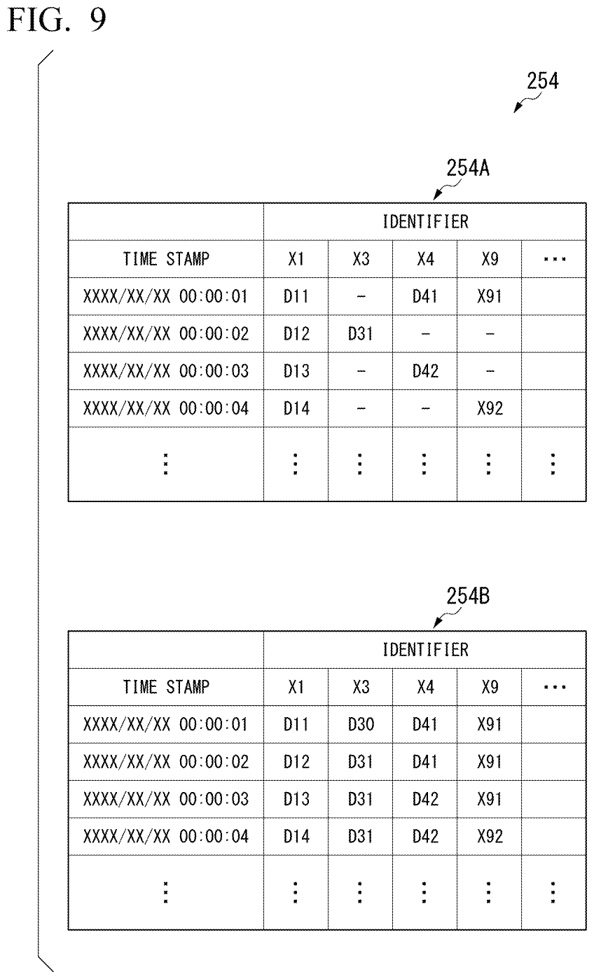

FIG. 9 is a view showing a data structure of the data table 254. The data table 254 stores the data collected by the data collection device 11. The data table 254 includes a raw data table 254A and a time series data table 254B. The raw data table 254A stores the collected unified data object itself. That is, the raw data table 254A stores the identifiers of the data, the values of the data, and the time stamps in association with each other. Since the collection cycle of the data in a PULL format is determined in the processing condition table 252, not all the data are collected in the same cycle. Additionally, there is a possibility that the transmission cycle of the data in a PUSH format data varies for each component. Therefore, the values of the time stamps of the data recorded in the raw data table 254A may not be the same between the plurality of kinds of data. For example, as shown in FIG. 9, in the raw data table 254A, the values of the data related to an identifier X1 and an identifier X3 are recorded at time XXXX/XX/XX 00:00:02. However, the value of the data related to an identifier X4 and an identifier X9 is not recorded.

For that reason, a unified data object with a uniform time stamp is stored in the time series data table 254B so that the values of the data related to all the identifiers as collection targets can be obtained when one time is specified. That is, the collected unified data object and the unified data object generated by processing the unified data object are stored in the time series data table 254B.

The processing condition reception unit 211 receives, from the data server 30, processing condition information that defines collection conditions that are conditions for collecting data related to the work machine 10 and transmission conditions that are conditions for transmission. The processing condition information related to the collection conditions includes, for example, an identifier indicating the type of data to be collected and a distribution method and a collection cycle of the data. The collection cycle is defined in a case where the collection method is PULL. The processing condition information related to the transmission condition includes an identifier indicating the type of data to be transmitted and a transmission cycle of the data. In addition, the distribution method may not be stored in the processing condition table 252 but may be stored in the collection method table 251.

The processing condition reception unit 211 updates the processing condition table 252 on the basis of the received processing condition information.

The collection determination unit 212 refers to the processing condition table 252 at each timing related to a predetermined processing cycle and determines whether or not there is data to be collected at the current timing. In a case where there is data to be collected, the collection determination unit 212 specifies an identifier of the data to be collected.

The collection method specification unit 213 refers to the collection method table 251 and specifies a data collection method for each identifier specified by the collection determination unit 212. Additionally, the collection method specification unit 213 specifies, for each identifier, whether or not a component that generates data related to the identifier is connected to the first circuit board 100 or the second circuit board 200.

The collection instruction output unit 214 outputs a data collection instruction to the first circuit board 100 for the data generated by a component connected to the first circuit board 100, that is, the control component 12 or the sensor 13 among the data to be collected. The collection instruction includes a data identifier and a collection method specified by the collection method specification unit 213.

The data acquisition unit 215 acquires the data collected by the first circuit board 100 in accordance with a collection instruction from the first circuit board 100. That is, the data acquisition unit 215 acquires a unified data object from the first circuit board 100.

The collection unit 216 acquires the data generated by a component connected to the second circuit board 200, that is, the extension component 14, among the data to be collected, in accordance with a collection method specified by the collection method specification unit 213.

The conversion unit 217 generates a unified data object by converting the data collected by the collection unit 216 into data in a unified format. Additionally, the conversion unit 217 converts the unified data object into a format related to the communication of the CAN. That is, the conversion unit 217 generates the unit data of the CAN in which values related to a plurality of unified data objects are stored in a data part.

The data registration unit 218 registers a unified data object acquired by the data acquisition unit 215 and a unified data object converted by the conversion unit 217 in the raw data table 254A and the time series data table 254B of the data table 254. Additionally, the data registration unit 218 generates a unified data object related to an identifier that has not been collected at that timing, and registers the unified data object in the time series data table 254B.

The collectable list notification unit 219 notifies the data server 30 of a collectable list that is a list of identifiers stored in the collectable table 253. For example, the collectable list notification unit 219 may provide a notification of the collectable list at the timing when the collectable table 253 is updated.

The data transmission unit 220 refers to the processing condition table 252 at each timing related to a processing cycle, reads a unified data object to be transmitted at the current timing from the data table 254, and transmits the unified data object to the data server 30. In addition, the data transmission unit 220 according to another embodiment may transmit the unified data object to a device other than the data server 30. For example, the data transmission unit 220 may transmit the unified data object to a device different from the second circuit board 200 included in the data collection device 11. That is, the data transmission unit 220 transmits the unified data object to the outside.

Additionally, the data transmission unit 220 outputs the unit data generated by the conversion unit to the extension component 14 depending on the request of the extension component 14.

### (Configuration of Data Server 30)

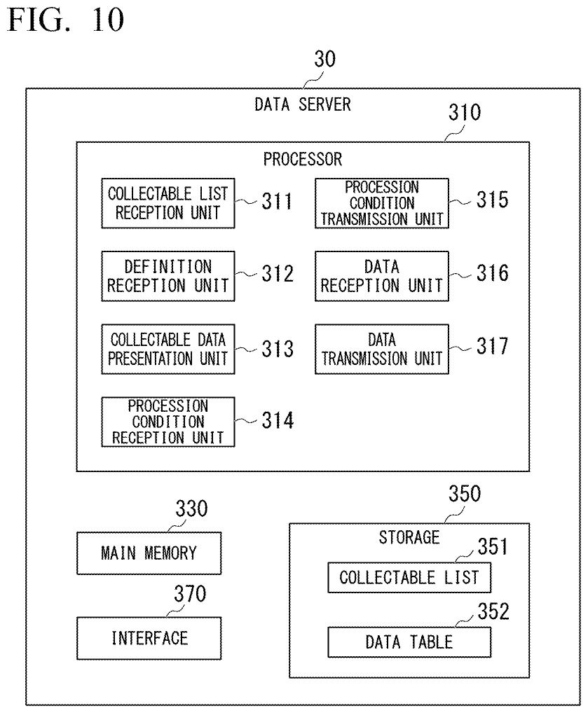

FIG. 10 is a block diagram showing a configuration of the data server 30 according to the first embodiment.

The data server 30 includes a processor 310, a main memory 330, a storage 350, and an interface 370. The processor 310 reads a program from the storage 350, develops the program into the main memory 330, and executes predetermined processing in accordance with the program. The interface 370 is communicably connected to the data collection device 11, the definition database 50, and the user device 70.

The program stored in the storage 350 may be for realizing some of the functions exhibited by the data server 30. Additionally, in another embodiment, the data server 30 may include a custom LSI such as a PLD in addition to or instead of the above configuration. In this case, some or all of the functions realized by the data server 30 may be realized by the integrated circuit.

Examples of the storage 350 include HDDs, SSDs, magnetic disks, magneto-optical disks, CD-ROMs, DVD-ROMs, semiconductor memories, and the like. The storage 350 may be an internal medium directly connected to a bus line or an external medium connected to the data server 30 via the interface 370 or a communication line. Additionally, this program may be distributed to the data server 30 by a communication line, and the processor 310 may execute the program. In at least one embodiment, the storage 350 is a non-transitory tangible storage medium.

When the processor 310 executes a program stored in the storage 350, the processor 310 functions as a collectable list reception unit 311, a definition reception unit 312, a collectable data presentation unit 313, a processing condition reception unit 314, a processing condition transmission unit 315, a data reception unit 316, and a data transmission unit 317. Additionally, the storage 350 secures a storage region for the collectable table 351 and the data table 352.

The collectable table 351 stores identifiers related to all the data that is collectable in the plurality of work machines 10, respectively. That is, the collectable table 351 stores the machine IDs of the work machines 10 and the data identifiers in association with each other. The machine ID is an example of identification information of a work machine.

The data table 352 stores unified data objects transmitted from the plurality of work machines 10, respectively. That is, the collectable table 351 stores the machine IDs of the work machines 10, the identifiers of the data, the values of the data, and the time stamps in association with each other.

The collectable list reception unit 311 receives a collectable list from the data collection device 11 of the work machine 10. The collectable list reception unit 311 updates the collectable table 351 on the basis of the received collectable list.

The definition reception unit 312 receives definition information indicating the definition of the data related to an identifier of a unified data object from the definition database 50. The definition information includes at least a display name and description of the data. The display name of the data is, for example, a character string expressed in a natural language such as “engine speed”. The definition information will be described below.

The collectable data presentation unit 313 presents to the user device 70 a collectable data list for each work machine 10 stored in the collectable table 351. In this case, the collectable data list generated by the collectable data presentation unit 313 includes the display name and the description included in the definition information. Accordingly, a user can understand the meaning of the data that the work machine 10 can collect. More specifically, the collectable data presentation unit 313 receives the input of the machine ID of the work machine 10 from the user device 70 and present a data list, which is collectable by the work machine 10 together with an input form for the processing condition information, to the user device 70.

The processing condition reception unit 314 receives the processing condition information from the user device 70. The user inputs the processing condition information on the basis of the list presented by the collectable data presentation unit 313. The input processing condition information is associated with the machine ID. In a case where the input processing condition information is defined by the display name, the processing condition reception unit 314 replaces the display name with an identifier on the basis of the definition information acquired by the definition reception unit 312.

The processing condition transmission unit 315 transmits the processing condition information input to the processing condition reception unit 314 to the data collection device 11 related to the associated machine ID.

The data reception unit 316 receives a unified data object from the data collection device 11.

The data transmission unit 317 transmits the received unified data object and the definition information related to the unified data object to the user device 70. Accordingly, when the data related to the unified data object is displayed, the user device 70 can display the display name and the like included in the definition information together. In this case, the data transmission unit 317 may replace the identifier related to the unified data object with the display name included in the definition information and then transmit the replaced display name to the user device 70 or may add the display name and the description to the unified data object and then transmit the added display name and the description to the user device 70.

### (Definition Database 50)

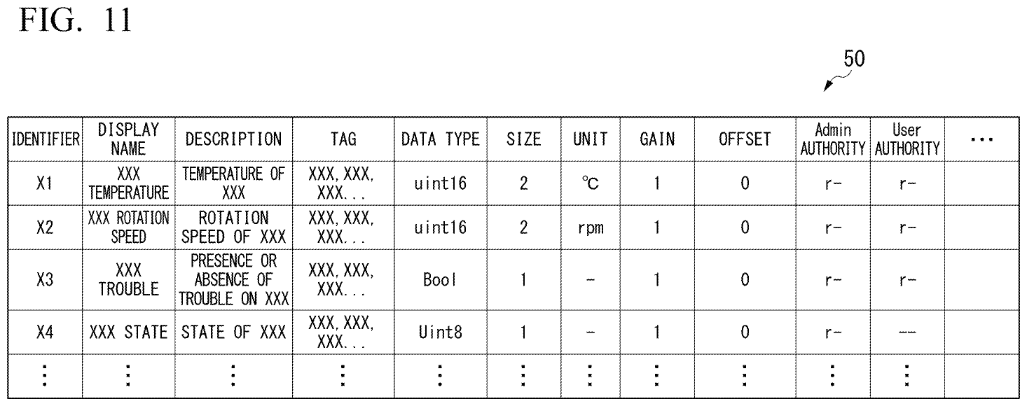

FIG. 11 is a view showing an example of the information stored in the definition database 50 according to the first embodiment.

The definition database 50 stores the definition information of data to which an identifier is given in association with the identifier related to a unified format. The definition information includes the display name, description, tag, data type, size, unit, gain, offset, and access authority for each user type. The display name and the description are a title and a description for the user to recognize the type of data. Examples of the access authority include access prohibition (- -), read-only (r-), and readable/writable (rw). Examples of the user type include an administrator (Admin authority), a user (user authority), and the like. Other user types may include developers, service providers, sellers, and the like.

### (Method of Setting Processing Conditions)

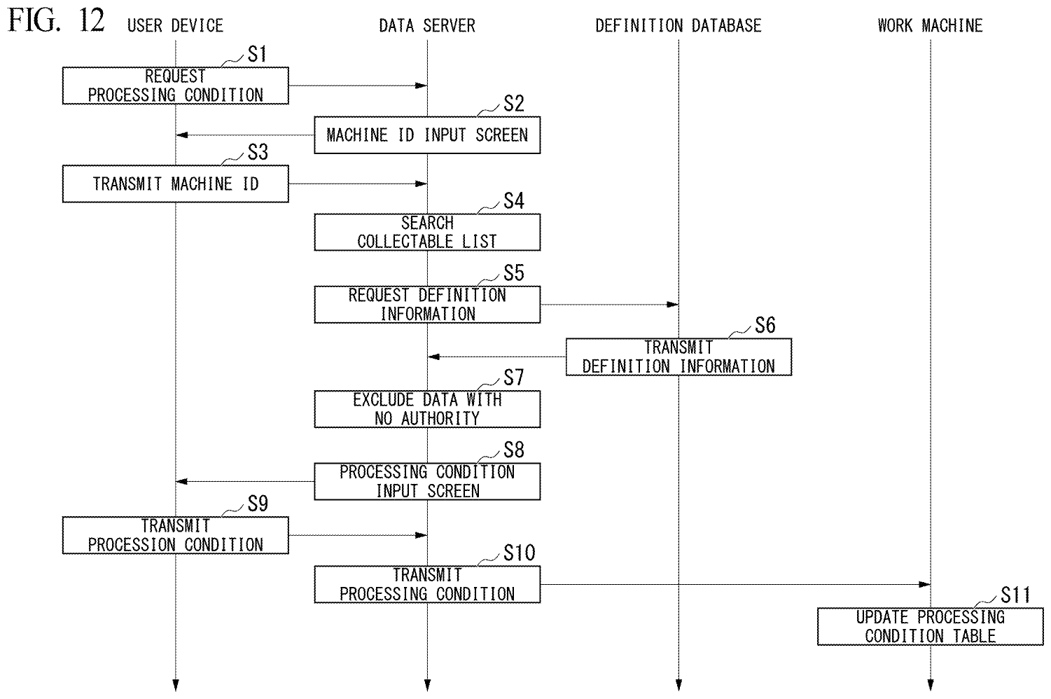

FIG. 12 is a sequence view showing a method of setting processing conditions in the data providing system 1 according to the first embodiment.

First, the user operates the user device 70 to access the data server 30. In this case, the user logs in to the data server 30 with his/her own preset account. A user type is allocated to the account in advance.

The user device 70 transmits a request for setting processing conditions to the data server 30 (Step S1). When the data server 30 receives the request for setting the processing conditions, the collectable data presentation unit 313 causes the user device 70 to display an input screen for the machine ID of the work machine 10 that is a setting target (Step S2). The input screen may be one in which the machine ID is directly input to a text box, or the machine ID may be selected from a list box.

The user inputs the machine ID of the work machine 10, which is the setting target, in accordance with the displayed input screen. The user device 70 transmits the input machine ID to the data server 30 (Step S3).

When the collectable data presentation unit 313 receives the machine ID from the user device 70, the collectable data presentation unit 313 refers to the collectable table 351 and searches for an identifier included in a collectable list associated with the received machine ID (Step S4). The definition reception unit 312 transmits a request for definition information related to the identifier in the collectable list specified by the search to the definition database 50 (Step S5). The definition database 50 transmits the definition information associated with the identifier to the data server 30 in accordance with the request received from the data server 30 (Step S6). The collectable data presentation unit 313 refers to the received definition information and excludes the searched identifiers that cannot be read by the authority of a logged-in user (Step S7). On the basis of the received definition information, the collectable data presentation unit 313 generates a processing condition input screen including display names and descriptions of all data that is collectable and can be read by the user, whether or not to collect the data, and an input form for collection conditions and transmission conditions, and causes the user device 70 to display the processing condition input screen (Step S8).

The user refers to the processing condition input screen displayed on the user device 70 and inputs the necessity of collection to the input form associated with each data. For the data that needs to be collected, the user inputs the collection conditions and the transmission conditions to the input form associated with the data. The user device 70 transmits the input processing condition information to the data server 30 (Step S9). When the processing condition reception unit 314 receives the processing condition information from the user device 70, the processing condition transmission unit 315 transmits the received processing condition information to the data collection device 11 related to the machine ID transmitted in Step S3 (Step S10).

The processing condition reception unit 211 of the data collection device 11 updates the processing condition table 252 on the basis of the received processing condition information (Step S11).

Accordingly, the processing conditions specified by the user can be set in the work machine 10 that is the setting target.

### (Data Collection Method)

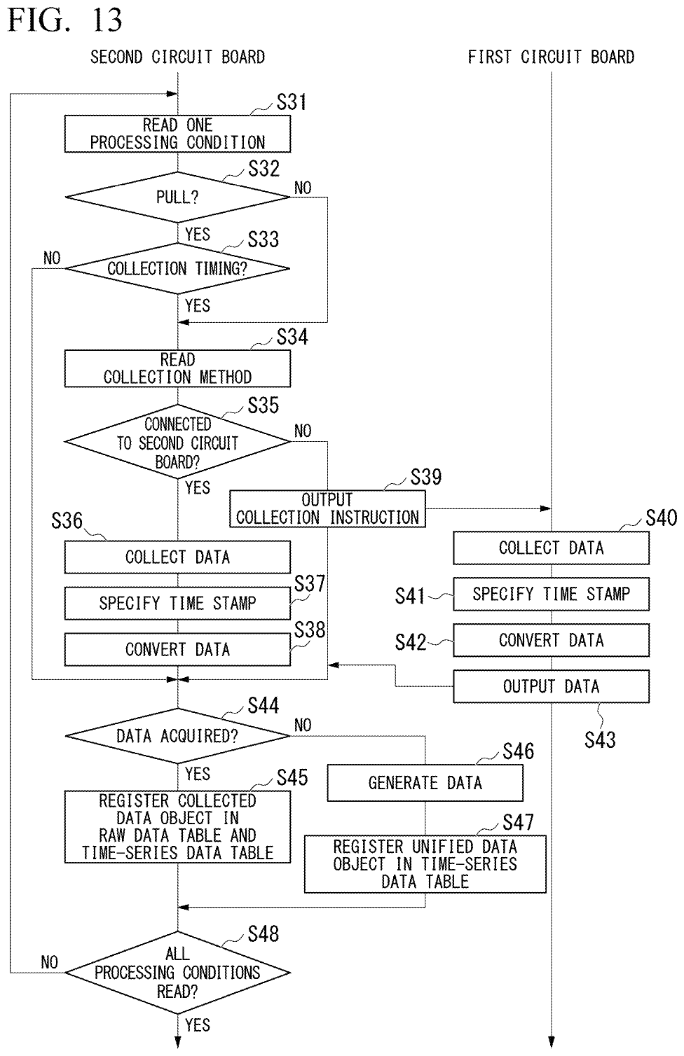

FIG. 13 is a sequence view showing a data collection method in the data providing system 1 according to the first embodiment.

The data collection device 11 executes the data collection processing shown in FIG. 13 at each predetermined control cycle. The collection determination unit 212 reads one processing condition that has not been read from the processing condition table 252 (Step S31). The collection determination unit 212 determines whether or not a collection method related to the read processing condition is PULL (Step S32).

In a case where the collection method is PULL (Step S32: YES), it is determined whether or not the current processing timing is a timing related to a collection cycle related to the read processing condition (Step S33). In a case where the current processing timing is not the timing related to the collection cycle (Step S33: NO), the data related to the processing condition is not collected.

On the other hand, in a case where the collection method is PUSH (Step S32: NO) or in a case where the collection method is PULL and the current processing timing is the timing related to the collection cycle (Step S33: YES), the collection method specification unit 213 refers to the collection method table 251 and reads a collection method associated with an identifier related to the read processing condition (Step S34). The collection method specification unit 213 determines whether or not a component capable of collecting target data is a component connected to the second circuit board 200 (Step S35).

In a case where a target component is connected to the second circuit board 200 (Step S35: YES), the collection unit 216 collects data from the component in accordance with the collection method read in Step S34 (Step S36). Specifically, in a case where the collection target data is the data distributed by the PULL method, the collection unit 216 transmits a data request to the component in accordance with the collection method and acquires a value from unit data transmitted as a response. In a case where the collection target data is data distributed by the PUSH method, the collection unit 216 acquires the value of the collection target data from unit data flowing through the network N2 or unit data directly distributed from the component. In addition, in a case where the distribution method is PUSH, it is not always possible to acquire data at the control timing. The collection unit 216 specifies the time when the data is collected as a time stamp (Step S37). The conversion unit 217 converts the collected data into a unified data object (Step S38). Specifically, the collection unit 216 generates a unified object by extracting only a value defined by the offset and the data length specified in the collection method from the data part of the unit data.

On the other hand, in a case where the target component is connected to the first circuit board 100 (Step S35: NO), the collection instruction output unit 214 outputs a collection instruction for data including the identifier of the collection target data and the collection method read in Step S34 to the first circuit board 100 (Step S39). In a case where the collection instruction input unit 111 of the first circuit board 100 receives the input of the collection instruction from the second circuit board 200, the collection unit 112 collects data from the component in accordance with the collection method included in the received collection instruction (Step S40). Specifically, in a case where the collection target data is the data distributed by the PULL method, the collection unit 112 transmits a data request to the component in accordance with the collection method, and acquires a value from unit data transmitted as a response. In a case where the collection target data is data distributed by the PUSH method, the collection unit 112 acquires the value of the collection target data from unit data flowing through the network N1 or unit data directly distributed from the component. In addition, in a case where the distribution method is PUSH, it is not always possible to acquire data at the control timing. The collection unit 216 specifies the time when the data is collected as a time stamp (Step S41). The conversion unit 113 converts the collected data into a unified data object (Step S42). The data output unit 114 outputs the converted unified data object to the second circuit board 200 (Step S43).

Next, the data registration unit 218 determines whether or not the data related to the processing condition read in Step S31 has been acquired (Step S44). In addition, in a case where the collection method is PULL and the component does not transmit data at the control timing, and in a case where the collection method is PUSH and the current processing timing is not the timing related to the collection cycle (Step S33: NO), the data related to processing condition cannot be acquired.

In a case where the data related to the processing condition is acquired (Step S44: YES), the data registration unit 218 registers the collected unified data object in the raw data table 254A and the time series data table 254B (Step S45). On the other hand, in a case where the data related to the processing condition is not acquired (Step S44: NO), the data registration unit 218 reads a unified data object related to a processing condition associated with the latest time stamp from the time series data table 254B and generates a new unified data object by rewriting a time stamp to the current time (Step S46). The data registration unit 218 registers the generated unified data object in the time series data table 254B (Step S47).

The collection determination unit 212 determines whether or not all the processing conditions have been read from the processing condition table 252 (Step S48). In a case where there is a processing condition that has not been read (Step S48: NO), the data collection device 11 returns the processing to Step S31 and reads the next processing condition. On the other hand, in a case where all the processing conditions are read (Step S48: YES), the data collection device 11 ends the data collection processing.

Accordingly, the data related to the processing condition is collected at a specified cycle. The collected data is transmitted to the data server 30 at each transmission cycle specified by the data transmission unit 220.

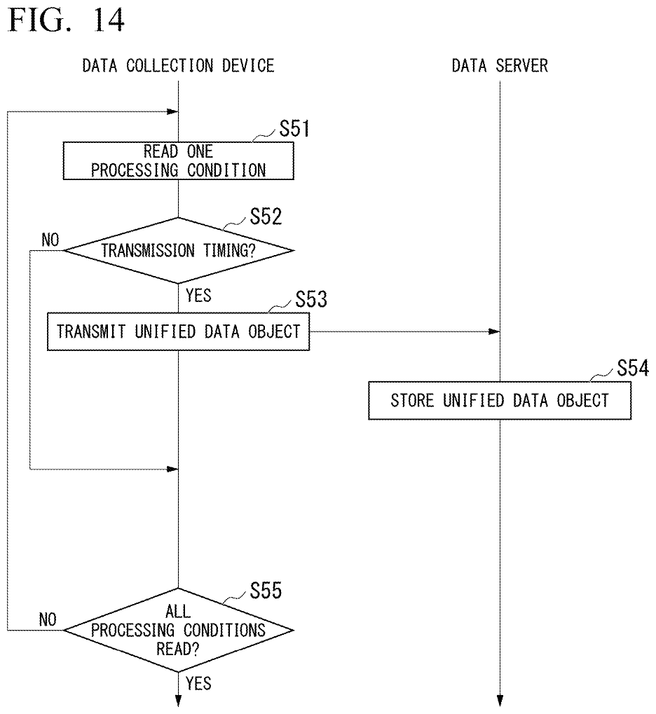

FIG. 14 is a sequence view showing a method of transmitting data in the data providing system 1 according to the first embodiment.

The data collection device 11 executes the data transmission processing shown in FIG. 14 at each predetermined control cycle. The data transmission unit 220 reads one transmission condition that has not been read from the processing condition table 252 (Step S51). The data transmission unit 220 determines whether or not the current processing timing is a timing related to a transmission cycle related to the read processing condition (Step S52). In a case where the current processing timing is not the timing related to the transmission cycle (Step S52: NO), the data related to the processing condition is not transmitted.

On the other hand, in a case where the current processing timing is the timing related to the transmission cycle (Step S52: YES), the data transmission unit 220 acquires a unified data object related to a processing conditions read from the data table 254 and transmits the acquired the unified data object to the data server 30 (Step S53). In this case, the data transmission unit 220 may transmit a unified data object of which an identifier is replaced with a display name.

In a case where the data reception unit 316 of the data server 30 receives the unified data object from the data collection device 11, the data reception unit 316 stores the received unified data object in the data table 352 (Step S54).

The data transmission unit 220 determines whether or not all the processing conditions have been read from the processing condition table 252 (Step S55). In a case where there is a processing condition that has not been read (Step S55: NO), the data collection device 11 returns the processing to Step S51 and reads the next processing condition. On the other hand, in a case where all the processing conditions are read (Step S55: YES), the data collection device 11 ends the data transmission processing.

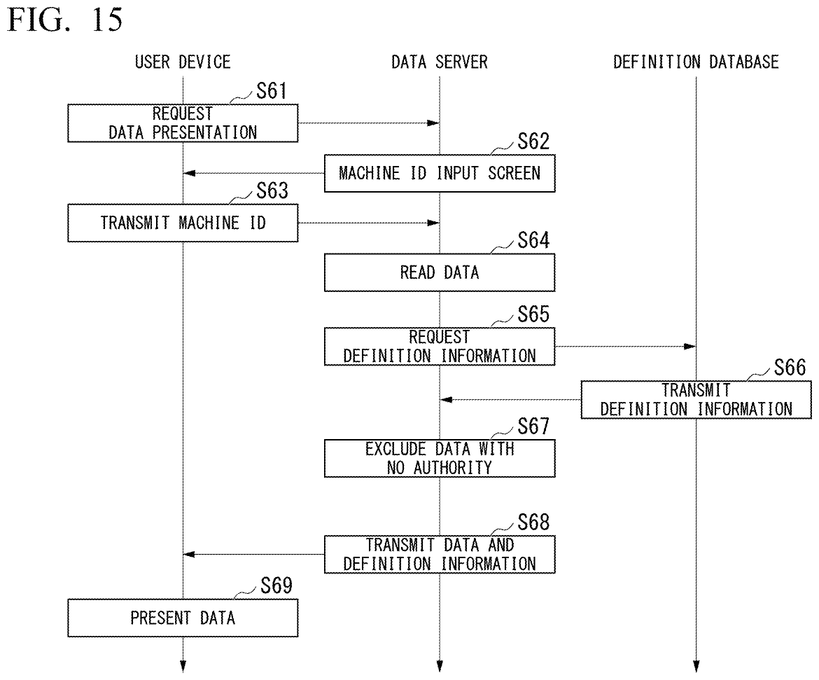

FIG. 15 is a sequence view showing a method of presenting data in the data providing system 1 according to the first embodiment.

First, the user operates the user device 70 to access the data server 30. In this case, the user logs in to the data server 30 with his/her own preset account. A user type is allocated to the account in advance.

The user device 70 transmits a data presentation request to the data server 30 (Step S61). When the data server 30 receives the data presentation request, the data transmission unit 317 causes the user device 70 to display the input screen of the machine ID of the work machine 10 that is a presentation target (Step S62). The input screen may be one in which the machine ID is directly input to a text box, or the machine ID may be selected from a list box. The input screen may be capable of receiving selection of a plurality of machine IDs.

The user inputs the machine ID of the work machine 10, which is the setting target, in accordance with the displayed input screen. The user device 70 transmits the input machine ID to the data server 30 (Step S63).

When the data transmission unit 317 receives the machine ID from the user device 70, the data transmission unit 317 refers to the data table 352 and searches for a unified data object associated with the received machine ID (Step S64). That is, the data transmission unit 317 searches for the data that is actually collected. The definition reception unit 312 transmits a request for definition information related to an identifier of a unified data object specified by the search to the definition database 50 (Step S65). The definition database 50 transmits the definition information associated with the identifier to the data server 30 in accordance with the request received from the data server 30 (Step S66).

The data transmission unit 317 refers to the received definition information and excludes the searched unified data objects that cannot be read by the authority of a logged-in user (Step S67). The data transmission unit 317 transmits the unified data object related to the data that can be read by the authority of the logged-in user and the definition information related to the unified data object to the user device 70 (Step S68). When the user device 70 receives the unified data object and the definition information from the data server 30, the user device 70 displays the received unified data object and the definition information (Step S69). For example, the user device 70 may replace the identifier included in the unified data object with a display name related to the definition information and display the replaced display name. Accordingly, the user device 70 can acquire the data collected from the work machine 10 related to the specified machine ID.

### (Action and Effect)

In this way, according to the first embodiment, the data collection device 11 collects data from a component provided in the work machine 10 in accordance with an individual protocol of the component, and converts the collected data into a unified data object and transmits the unified data object to the data server 30. Accordingly, the data server 30 can easily obtain desired data of a collection target. In addition, in another embodiment, the data collection device 11 may transmit the unified data object to an external device different from the data server 30. For example, the data collection device 11 may transmit the unified data object to a service tool connected to the second circuit board 200. The service tool is a terminal that a serviceman or a seller connects to the work machine 10 for work. Examples of the service tool include dedicated terminals and PCs.

Additionally, according to the first embodiment, the data collection device 11 includes the first circuit board 100 and the second circuit board 200 that are physically divided. Also, the first circuit board 100 includes the collection unit 112, and the second circuit board 200 includes the data transmission unit 220. Accordingly, it is possible to transmit the data acquired by a component connected to the first circuit board 100 to the outside while preventing the component connected to the first circuit board 100 from being directly accessed from an external device.

Since the control component 12 is connected to the first circuit board 100 according to the first embodiment, it is possible to prevent the operation of the control component 12 from being hindered by the extension component 14. Additionally, by dividing the first circuit board 100 and the second circuit board 200, the circuit boards can each be operated by different OSs. That is, a real-time OS can be run on the first circuit board 100, and ae general-purpose OS can be run on the second circuit board 200. Accordingly, data processing with high real-time property can be realized in the first circuit board 100, and data processing with high processing capability can be performed in the second circuit board 200.

Additionally, the first circuit board 100 according to the first embodiment includes the conversion unit 113. Accordingly, the first circuit board 100 and the second circuit board 200 can transmit and receive data to and from each other. Accordingly, a communication line connecting the first circuit board 100 and the second circuit board 200 to each other does not need to be a line corresponding to the CAN. That is, according to the first embodiment, the communication configuration between the first circuit board 100 and the second circuit board 200 can be simplified. Additionally, since the data generated by many components flows to the CAN, it is possible to collect the data with high time accuracy by giving a time stamp on the first circuit board 100 on which the real-time OS runs. Additionally, in another embodiment, the first circuit board 100 may store the data table 254. Accordingly, since the data is stored in the data table 254 by the real-time OS, the data collection device 11 can construct a data table with high time accuracy.

In addition, in another embodiment, one circuit board may have all the functions of the data collection device 11. Additionally, in another embodiment, the data collection device 11 may include three or more circuit boards. Additionally, in another embodiment, the roles of the plurality of circuit boards included in the data collection device 11 may be different from those in the first embodiment.

Additionally, in another embodiment, the data collection device 11 may include only one processor, memory, or storage. Additionally, in another embodiment, the first circuit board 100 may not include the conversion unit 113, and the second circuit board 200 may receive data from the first circuit board 100 in accordance with an individual protocol of a component.

Additionally, according to the first embodiment, the data collection device 11 specifies the individual protocol by referring to a collection method table that stores the type of data and the individual protocol. Accordingly, the data collection device 11 can easily specify an individual protocol for collecting the specified data.

Additionally, according to the first embodiment, the data collection device 11 can convert a unified data object into a format related to the individual protocol and output the converted unified data object to another component according to the individual protocol. Accordingly, the data collection device 11 can also output the collected data to components that do not correspond to the unified format. In addition, the data collection device 11 according to another embodiment may not have a function of converting the unified data object into the individual protocol and outputting the converted individual protocol.

Additionally, according to the first embodiment, the data server 30 refers to the definition database and provides the value of the data related to the unified data object received from the data collection device 11 in association with a display name thereof. Accordingly, the data server 30 can make the user understand the meaning of the data even when the value of the identifier is a character string having no meaning. In addition, in another embodiment, the data server 30 may not present the display name to the user. In this case, the user needs to separately check the type of data indicated by the identifier. Additionally, in another embodiment, the provision of the display name based on the definition information may be omitted by setting the value of the identifier to a character string such as a display name with which the meaning of the data can be understood. Additionally, in another embodiment, the data server 30 or the user device 70 may store the definition information and provide the data with reference to the definition information.

Additionally, according to the first embodiment, each of a plurality of users can set processing conditions such as collection conditions for one work machine 10. Accordingly, according to the first embodiment, one registrant can also set a plurality of processing conditions. The plurality of users may include users having different authorities.

Although one embodiment has been described in detail with reference to the drawings, the specific configuration is not limited to the above-described one, and various design changes and the like can be made.

For example, the unified data object according to the first embodiment has the unified format structure shown in FIG. 2 but is not limited to this. For example, in another embodiment, the unified data object may not have a time stamp. Also, for example, the unified data object may have other information.

Additionally, the processing conditions according to the first embodiment include, but are not limited to, the collection conditions and the transmission conditions. For example, the processing conditions according to another embodiment may include processing conditions for processing data. Additionally, the processing conditions according to another embodiments may include only the collection conditions or only the transmission conditions.

Additionally, the data collection device 11 according to the first embodiment collect data distributed by the PUSH method or the PULL method, but is not limited to this. For example, in a case where a component according to another embodiment stores data in an internal storage device, the data collection device 11 may collect data by accessing the storage device of the component and reading the data.

According to the present invention, the desired data relating to a work machine can be easily acquired from the outside of the work machine.

1. A data collection device for work machines that collects data from a component mounted on a work machine, the data collection device comprising:
a collection unit that collects the data from the component via a vehicle-mounted network; and
a conversion unit that generates a unified data object by converting the collected data into a predetermined format; and
a data transmission unit that transmits the unified data object to the outside.

2. The data collection device for work machines according to claim 1, further comprising:
a first circuit board on which a real-time OS runs; and
a second circuit board on which a general-purpose OS runs,
the first circuit board and the second circuit board being physically divided,
the collection unit being provided on the first circuit board, and
the data transmission unit being provided on the second circuit board.

3. The data collection device for work machines according to claim 2, wherein
the conversion unit is provided on the first circuit board, and
the data transmission unit transmits the unified data object acquired from the first circuit board to the outside.

4. The data collection device for work machines according to claim 1, further comprising:
a collection method specification unit that specifies a collection method with reference to a collection method table that stores
a type of data that is acquirable from the component and
a collection method useable to acquire the data.

5. The data collection device for a work machine according to claim 4, wherein
the conversion unit converts the collected data into the unified data object based on an offset and a data length of the data stored in the collection method.

6. The data collection device for work machines according to claim 1, further comprising:
a data output unit that outputs data related to the unified data object to another component mounted on the work machine,
the conversion unit converting the unified data object into data in a format related to the vehicle-mounted network, and
the data output unit outputting the data in the format related to the vehicle-mounted network.

7. A data providing system for work machines, the data providing system including a plurality of work machines including the data collection device according to claim 1, the data providing system further comprising:
a data server that receives the unified data object from the data collection device provided in each of the plurality of work machines, the data server including
a data reception unit that receives the unified data object from the data collection device, and
a data transmission unit that
receives a data presentation request including identification information of the work machine from outside and
transmits the unified data object received from the data collection device of the work machine corresponding to the identification information.

8. The data providing system for work machines according to claim 7, wherein
the unified data object has a data structure including an identifier that specifies a type of data and a value of the data, and
the data transmission unit
refers to definition information in which the identifier and a display name of data related to the identifier are stored in association with each other and
transmits the value of the data related to the received unified data object and the display name in association with each other.

9. A data collection method for work machines, the data collection method being useable to collect data from a component mounted on a work machine, the data collection method comprising:
collecting the data from the component via a vehicle-mounted network;
generating a unified data object by converting the collected data into a predetermined format; and
transmitting the unified data object to the outside.
